(19) United States
(12) Patent Application Publication
(10) Pub. No.: US 2025/0370190 A1
(43) Pub. Date: Dec. 4, 2025

(54) METHOD AND APPARATUS FOR THE RAPID CHARACTERIZATION OF PHOTONIC DEVICES USING EVANESCENT COUPLING VIA DIRECT LASER WRITTEN TAPERED POLYMER EVANESCENT COUPLERS

(71) Applicant: Government of the United States of America, as represented by the Secretary of Commerce, Gaithersburg, MD (US)

(72) Inventors: Kartik Arvind Srinivasan, Rockville, MD (US); Edgar Perez, College Park, MD (US)

(21) Appl. No.: 19/223,455

(22) Filed: May 30, 2025

Related U.S. Application Data
(60) Provisional application No. 63/654,272, filed on May 31, 2024.

(51) Int. Cl. G02B 6/293; G02B 6/30

(52) U.S. Cl. CPC G02B 6/29331; G02B 6/305

(57) ABSTRACT

Exemplary tapered polymer optical probes (TPOPs), are highly customizable probes for characterization of photonic integrated circuits that move the optical infrastructure from on-chip to off-chip while providing additional utility than the on-chip infrastructure. TPOPs can be customized to meet specific coupling requirements, support the efficient use of on-chip area, provide in-situ tunability, and can access photonic devices in environments that are usually difficult to work in.

### RELATED APPLICATIONS

This application claims the benefit of U.S. Provisional Patent Application Ser. No. 63/654,272 (filed May 31, 2024), which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to integrated photonics, and more particularly to characterization of photonic devices using evanescent coupling.

### BACKGROUND

Integrated photonic devices play an important role in industries like telecommunications and precision measurement. Conventional practices for probing and characterizing on-chip photonic devices typically demand on-chip optical infrastructure that consume design and fabrication resources as well as valuable on-chip surface area.

### SUMMARY OF INVENTION

Exemplary tapered polymer optical probes (TPOPs), are highly customizable probes that move the optical infrastructure from on-chip to off-chip while providing additional utility than the on-chip infrastructure. TPOPs can be customized to meet specific coupling requirements, support the efficient use of on-chip area, provide in-situ tunability, and can access photonic devices in environments that are usually difficult to work in.

Importantly, a single TPOP device can be used to characterize numerous optical devices, does not break easily, and can function as a drop-in replacement for existing (more cumbersome) technologies.

According to an aspect of the invention, a tapered polymer optical probe assembly includes an input channel; an output channel; and a generally u-shaped waveguide having a pair of legs respectively extending longitudinally out from and optically coupling the input channel and output channel and a waist portion at a distal end of the waveguide connecting the pair of legs and forming, along with distal portions of the legs, a bight of the generally u-shaped waveguide. The waveguide has a waist diameter that is configured to be sufficiently small to produce evanescent waves that couple to and from a device under test when the distance between the waist the device under test is sufficiently small.

Optionally, the legs extend in a direction out of a primary plane of the tapered polymer optical probe.

Optionally, the legs extend transversely outward in a primary plane of the tapered polymer optical probe forming a bulging bight shape with the waist.

Optionally, a cross-section of the waveguide is circular.

Optionally, a cross-section of the waveguide is oval.

Optionally, a cross-section of the waveguide is rectangular.

Optionally, a cross-section of the waveguide changes over its length.

Optionally, the waveguide has a leg diameter at proximal ends that tapers down to the waist diameter, the waist diameter being smaller than the leg diameter.

According to another aspect of the invention, a method of making a tapered polymer optical probe assembly using direct laser writing includes the steps of forming a substrate with at least one optical input channel and one optical output channel; depositing photoresist appropriate for direct laser writing on the substrate; exposing the photoresist using direct laser writing, thereby forming a waveguide; developing photoresist using a low surface tension solvent or a developer appropriate to the photoresist; and removing the developer in a critical point dryer or by evaporation.

Optionally, the step of exposing photoresist includes forming additional support structure for alleviating surface tension and providing mechanical support to the waveguide.

Optionally, the waveguide is generally u-shaped and has a pair of legs respectively extending longitudinally out from and optically coupling the input channel and output channel and a waist portion at a distal end of the waveguide connecting the pair of legs and forming, along with distal portions of the legs, a bight of the generally u-shaped waveguide.

Optionally, the waist diameter is configured to be sufficiently small to produce evanescent waves that couple to and from a device under test when the distance between the waist the device under test is sufficiently small.

Optionally, the legs extend in a direction out of a primary plane of the tapered polymer optical probe.

Optionally, the legs extend transversely outward in a primary plane of the tapered polymer optical probe forming a bulging bight shape with the waist.

Optionally, a cross-section of the waveguide is circular.

Optionally, a cross-section of the waveguide is oval.

Optionally, a cross-section of the waveguide is rectangular.

Optionally, a cross-section of the waveguide changes over its length.

Optionally, the substrate includes a fiber array.

Optionally, the substrate includes a multi-core fiber.

Optionally, the substrate includes a photonic integrated circuit.

Optionally, the waveguide has a leg diameter at proximal ends that tapers down to a waist diameter, the waist diameter being smaller than the leg diameter.

The foregoing and other features of the invention are hereinafter described in greater detail with reference to the accompanying drawings.

### BRIEF DESCRIPTION OF THE DRAWINGS

FIG. 1 shows a schematic comparing the chip-layouts for the testing of a first Device Under Test (DUT) and a second DUT (DUTA and DUTB, respectively). (a) A layout typically used when on-chip waveguides proved access to the DUTs. (b) The layout one can use with off-chip access waveguides like Tapered Polymer Optical Probes (TPOPs).

FIG. 2 shows a schematic diagram of an exemplary Tapered Polymer Optical Probe (TPOP) apparatus. TPOP connects an input port and an output port (fibers in this example) with a customizable 3-dimensional waveguide with a very small waist diameter (Do). A small waist leads to an evanescent coupling of the input fields to the DUT, when the distance (d) from the waist to the DUT is very small. The TPOP may be customized to minimize loss in connecting the input and output ports while producing the small waist that gives an evanescent tail for probing. This is done by the tapering of the cross-section.

FIG. 3 shows a freeform customization of a TPOP that can be customized in the x-y plane depicted by the coordinate vectors in the image by engineering the coupling region for a specific application. For example, a point-like coupling region (left) or an extended coupling region (right) can be employed.

FIG. 4 shows more customization of a TPOP in the plane of the taper.

FIG. 5 shows more customization of a TPOP, this time in the y-z plane, enabling, e.g., a TPOP to approach a DUT at angles that would otherwise be hard to reach.

FIG. 6 shows more customization of a TPOP, this time in the choice of cross-sectional shape of the waveguide.

FIG. 7 shows a step in an exemplary method of making an exemplary TPOP device.

FIG. 8 shows a step in an exemplary method of making an exemplary TPOP device.

FIG. 9 shows a step in an exemplary method of making an exemplary TPOP device.

FIG. 10 shows a step in an exemplary method of making an exemplary TPOP device.

FIG. 11 shows a step in an exemplary method of making an exemplary TPOP device.

FIG. 12 shows a variety of waveguide substrate types.

### DETAILED DESCRIPTION

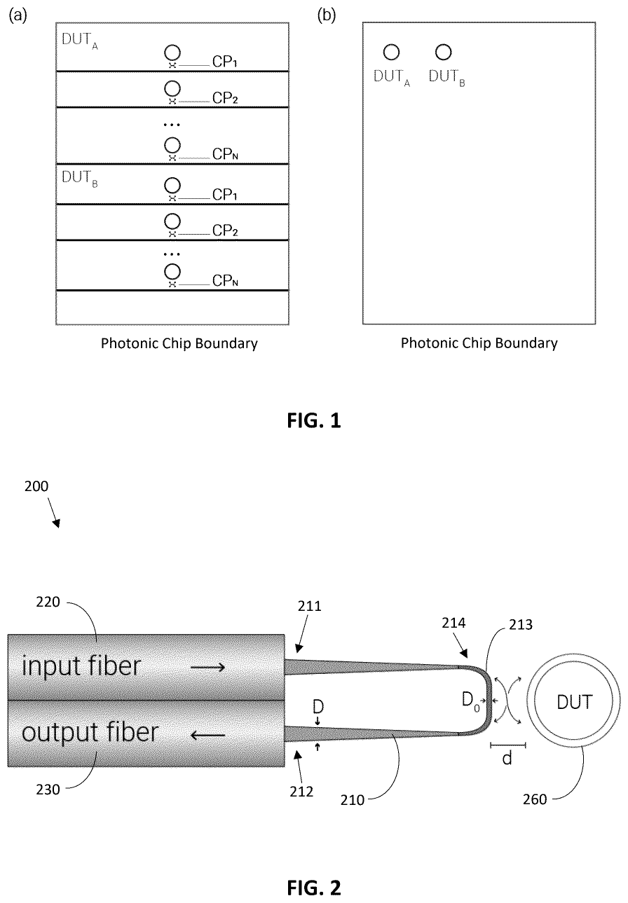

Described herein is an apparatus for the rapid and flexible characterization of on-chip photonic devices through evanescent coupling that may be fabricated with direct laser writing (DLW). On-chip photonic devices are usually fabricated alongside on-chip waveguides that couple light into and out of a Device Under Test (DUT). These on-chip waveguides (or similar alternatives), require resources to design and fabricate and often occupy more physical space on the photonic chips than the DUTs themselves. Furthermore, the coupling rate between an access waveguide and a DUT can dramatically affect the DUT's performance, so a DUT in development is often fabricated many times on a chip, with slight changes to the coupling parameters between it and its access waveguide. FIG. 1(a) illustrates a common layout strategy for a DUT in development, highlighting the inefficient use of space caused by the need for various coupling parameter variations when compared with the layout that may be used with exemplary off-chip access waveguides shown in FIG. 1(b). Beyond inefficient layouts, replication of the DUT in conventional devices means that a single DUT is tested many times (each with different coupling parameters), which further slows down the characterization speed of an on-chip device.

An exemplary apparatus, a Tapered Polymer Optical Probe (TPOP) 200, shown in FIG. 2, may include a customizable 3-dimensional (3D) waveguide 210 that connects an input channel 220 and output channel 230 (shown as fibers in the figure). The waveguide 210 may be a direct laser written waveguide. The waveguide 210 has a diameter D at proximal ends 211 and 212 that tapers down to a waist diameter Do at a waist 213 at a distal end 214 of the TPOP. The diameter D is configured to optimize coupling to input channel 220 and output channel 230. The waist diameter Do is configured to be sufficiently small to produce evanescent waves that couple to and from a DUT 260 when the distance d between the TPOP waist 213 and the DUT 260 is sufficiently small. By controlling d, which can be done in-situ, either manually or automatically via a computer and actuator, the interaction strength between the TPOP and the DUT can be modified, eliminating the need to replicate the same DUT with different coupling parameters as required with conventional on-chip waveguides and shown in FIG. 1.

The TPOP connects an input port and an output port (fibers in this example) with a customizable 3-dimensional waveguide with a very small waist diameter (D₀). A small waist leads to an evanescent coupling of the input fields to the DUT, when the distance (d) from the waist to the DUT is very small. The TPOP may be customized to minimize loss in connecting the input and output ports while producing the small waist that gives an evanescent tail for probing. This is done by the tapering of the cross-section.

The waveguide 210 extends longitudinally outward from the output fibers in a generally u-shaped path, as shown. The waist 213 portion of the waveguide extends transverse to this longitudinal direction and defines, with the longitudinal direction a primary plane of the waveguide 210 (parallel to and coincident with the page of the figure).

The core coupling and access mechanisms used in exemplary TPOP devices will be understood by those having ordinary skill in the art after reading and understanding the present disclosure. Bringing a Pulled Optical Fiber (POF) close to a DUT is a conventional method for device characterization. However, there are a few key advantages available to exemplary TPOP devices that are either challenging or absent in the conventional POF approach. The biggest difference, however, is in the manufacturability of the devices and, by extension, their customization. Several advantages are detailed below.

Conventional POFs are usually fabricated on custom setups inside of research laboratories with limited process control and result in large and fragile structures that can be cumbersome to work with and difficult to customize. On the other hand, exemplary TPOP devices may be manufactured with sub-micron accuracy using direct laser writing, a state-of-the-art nanolithography process, in a single lithography step that can take place outside of a cleanroom environment. In contrast, other attempts to replace conventional POF with nanolithographically-fabricated devices has resulted in devices that require up to 7 lithography steps including pattering with an electron-beam and other demanding infrastructural requirements.

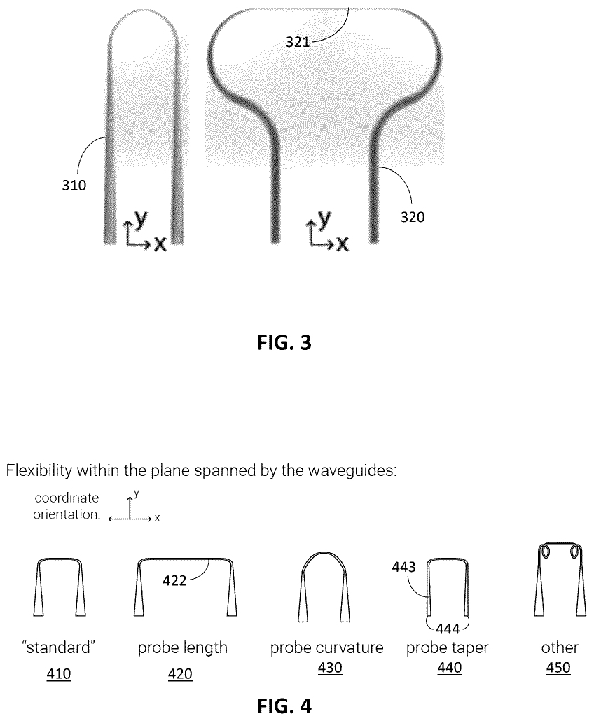

The precision allowed for in the manufacturing of exemplary TPOP devices brings customization and, thereby, additional utility to the TPOP device. FIG. 3 shows two examples of how a TPOP may be customized to suit specific probing needs. The first panel shows 2-dimensional customization in the primary (x-y) plane with a basic u-shaped waveguide 310 on the left and a waveguide 320 on the right, having a bulging bight that gives a longer waist 321 and an overall shape to the waveguide akin to a cotter pin.

Turning now to FIG. 4, other customizations in the primary (x-y) plane are shown. The first waveguide 410 shows what might be considered a standard waveguide to which other configurations may be compared. The length of the waist 422 of waveguide 420 is lengthened as compared with waveguide 410, without altering the turning radius or changing the overall shape (as distinguishable from the “cotter-pin” configuration shown in 320). Additionally or alternatively, the turning radius may be altered, as shown in waveguide 430, to give the guide a more gentle curvature. Additionally or alternatively, the tapering of the waveguide 440 legs 443 may be changed, either narrowing (as shown) or widening (not shown) the proximal ends 444. Additionally or alternatively, the waveguide 450 may include twists, jogs, or other paths that change the shape of the legs or waist of the waveguide. It is noted that these alterations may be applied singly or in combination with each other, and with other alterations previously discussed or discussed below.

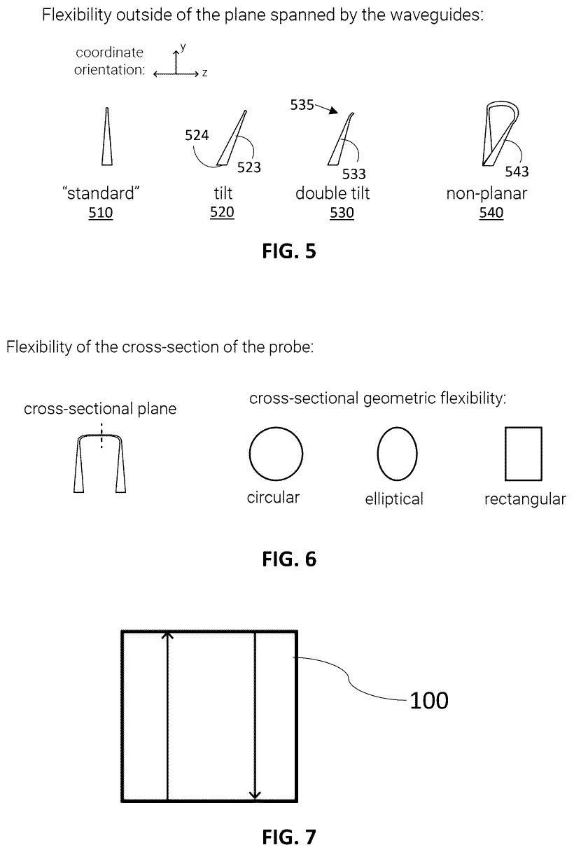

Turning now to FIG. 5, customizations outside the primary (x-y) plane—customizations in the transverse (y-z) plane—are shown. The first waveguide 510 shows what might be considered a standard waveguide to which other configurations may be compared. Waveguide 520 shows one in which the entire waveguide is skewed into the transverse (y-z) plane, coming out at an angle and having proximal ends 524 at a non-orthogonal angle with respect to the legs 523. Additionally (as shown), or alternatively, the waveguide 530 shows a second tilt in which a distal portion 535 of the legs 533 bend in the transverse (y-z) plane. Although shown with a bend further in the direction of the proximal tilt, the distal bend may instead bend in the opposite direction (back towards the primary plane), resulting in a configuration in which the waist is offset from the primary plane, but with the distal end of the waveguide potentially parallel to the primary plane. Additionally or alternatively, the waveguide 540 may include legs 543 that are tilted or bend asymmetrically, resulting in a non-planar configuration or a configuration in a plane rotated about the longitudinal axis. It is noted that these alterations may be applied singly or in combination with each other, and with other alterations previously discussed or discussed below.

Turning now to FIG. 6, shown are exemplary cross-section of the waveguide 610. It is noted that the cross-section of a waveguide need not be uniform along its length. It may, instead change at any one or more individual points or continuously along its length. In some embodiments, e.g., the legs of a waveguide may have a first cross-sectional shape and the waist of that waveguide may have a second cross-sectional shape, different from the first. Some example cross-sectional shapes include the circular, ovular (including elliptical), and rectangular (including square) shapes shown in FIG. 6, but these are not exhaustive. Cross-section can, in fact, be almost any shape that is within the resolution limits (currently, approximately 200 nm) of the lithography technique. The cross-sectional shape of a TPOP waveguide may change, for example, from circular to elliptical, to provide a control over the polarization of the input field. This functionality and flexibility in design starkly contrasts with the limited customizability available to POFs, where the options are generally limited to circular geometries of various radii of curvature.

The material (polymer) used in TPOPs may make them less fragile than POFs, which are made of silica (glass) fibers. Since silica is a very stiff material, when it is thinned down to very small D₀, it becomes a very fragile instrument, hard to maneuver, and requires large clearances in the vicinity of a photonic chip. This is especially restricting for POFs considering that their fabrication is cumbersome and typically requires custom-built setups. On the other hand, the polymer in TPOPs is not stiff and does not require large clearances. This makes TPOPs easy to use and harder to break than POFs, and it allows TPOPs to operate in tight spaces like cryostats. Instead of snapping the way a stiff material would, the polymer in a TPOP allows for deformation during collision. After a collision, the elasticity of the polymer allows it to return to a less deformed state in which the TPOP remains operational, demonstrating TPOP resiliency to mechanical perturbations.

Because TPOP uses a long and thin waveguided suspended in space, it is intrinsically a difficult structure to fabricate. A common failure mode for the TPOP devices is when the suspended waveguide sags after fabrication. This issue may be resolved with a critical point drying fabrication step.

Referring now to FIGS. 7-11, an exemplary process for making an exemplary TPOP device includes the following steps.

As shown in FIG. 7, a substrate 100 with at least one optical input channel and one optical output channel is formed.

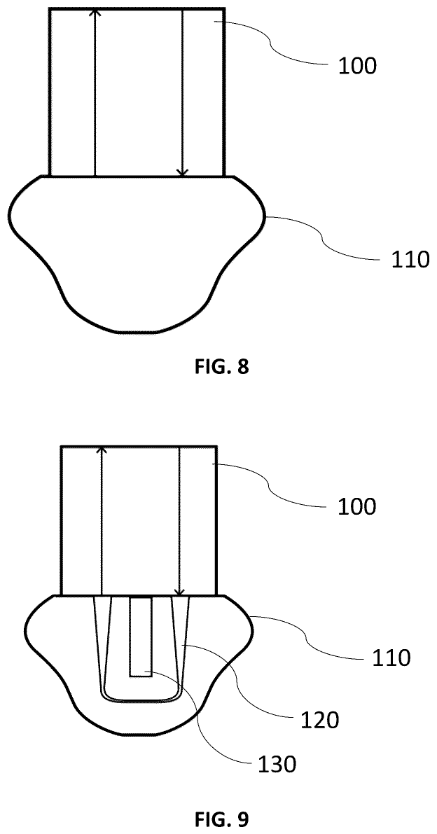

At FIG. 8, drop cast photoresist 110 appropriate for direct laser writing is deposited on the substrate 100.

At FIG. 9, using direct laser writing, the photoresist 110 may be exposed to create a TPOP device waveguide 120 and any additional support structures 130 needed for alleviating surface tension and providing mechanical support. Additional support structures depend on the mechanical stability of the TPOP design, the photoresist viscosity, and surface tension during the developing process.

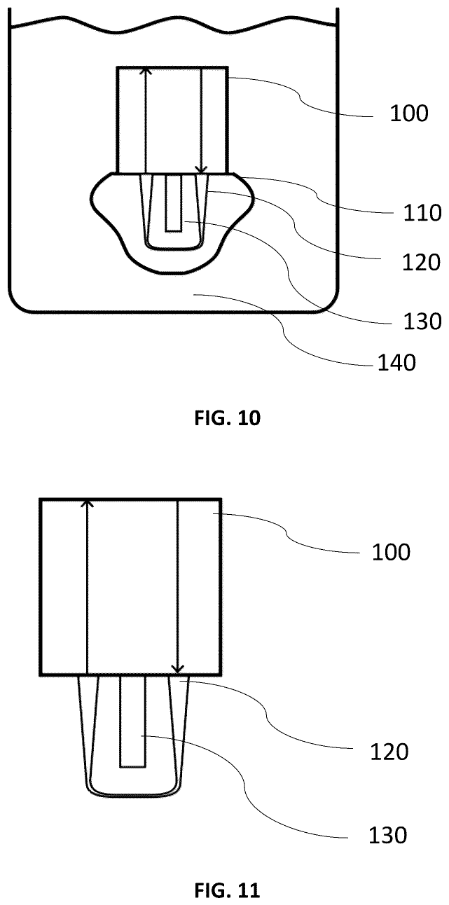

At FIG. 10, the resist may be developed using a low surface tension solvent 140 or a developer appropriate to the photoresist in use.

At FIG. 11, the developer 140 may be removed from the device in a critical point dryer or by evaporation, depending on the mechanical stability of the TPOP design.

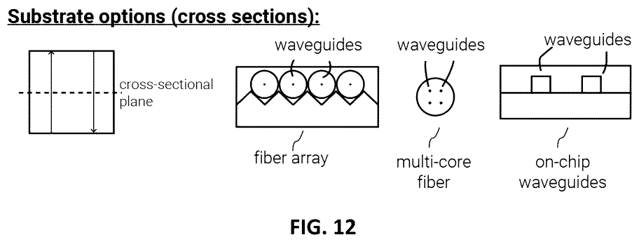

Turning now to FIG. 12, TPOP devices can be fabricated on a variety of waveguide substrates, including, e.g., in a fiber array, as part of a multi-core fiber, and/or as on-chip waveguides.

TPOPs are a practical tool for the rapid characterization of photonic devices that would be a useful tool in academic laboratories as well as industrial settings. In the microelectronics/semiconductor processing industry, electronic probes are used ubiquitously for statistical process control and quality assurance at the wafer scale. TPOPs provide an opportunity for similar tools to be developed for optical (rather than electronic) devices. TPOPs could not only help researchers develop new devices faster in the lab, but they have the potential to reduce the time-to-commercialization in industry environments as well.

There are no practical conventional alternatives for TPOPs. Impractical alternatives for TPOPs include POFs, but TPOPs are much easier to manufacture, much more durable, and much easier to work with, and TPOPs work in environments where POFs do not. Finally, TPOPS can make the use of on-chip space dramatically more efficient during the prototyping stage of a new photonic device.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A tapered polymer optical probe assembly comprising:
an input channel;
an output channel; and
a generally u-shaped waveguide having a pair of legs respectively extending longitudinally out from and optically coupling the input channel and output channel and a waist portion at a distal end of the waveguide connecting the pair of legs and forming, along with distal portions of the legs, a bight of the generally u-shaped waveguide,
wherein a waist diameter is configured to be sufficiently small to produce evanescent waves that couple to and from a device under test when the distance between the waist the device under test is sufficiently small.

2. The tapered polymer optical probe assembly of claim 1, wherein the legs extend in a direction out of a primary plane of the tapered polymer optical probe.

3. The tapered polymer optical probe assembly of claim 1, wherein the legs extend transversely outward in a primary plane of the tapered polymer optical probe forming a bulging bight shape with the waist.

4. The tapered polymer optical probe assembly of claim 1, wherein a cross-section of the waveguide is circular.

5. The tapered polymer optical probe assembly of claim 1, wherein a cross-section of the waveguide is oval.

6. The tapered polymer optical probe assembly of claim 1, wherein a cross-section of the waveguide is rectangular.

7. The tapered polymer optical probe assembly of claim 1, wherein a cross-section of the waveguide changes over its length.

8. The tapered polymer optical probe assembly of claim 1, wherein the waveguide has a leg diameter at proximal ends that tapers down to the waist diameter, the waist diameter being smaller than the leg diameter.

9. A method of making a tapered polymer optical probe assembly using direct laser writing, the method comprising the steps of:
forming a substrate with at least one optical input channel and one optical output channel;
depositing photoresist appropriate for direct laser writing on the substrate;
exposing the photoresist using direct laser writing, thereby forming a waveguide;
developing photoresist using a low surface tension solvent or a developer appropriate to the photoresist; and
removing the developer in a critical point dryer or by evaporation.

10. The method of claim 9, wherein the step of exposing photoresist includes forming additional support structure for alleviating surface tension and providing mechanical support to the waveguide.

11. The method of claim 9, wherein the waveguide is generally u-shaped and has a pair of legs respectively extending longitudinally out from and optically coupling the input channel and output channel and a waist portion at a distal end of the waveguide connecting the pair of legs and forming, along with distal portions of the legs, a bight of the generally u-shaped waveguide.

12. The method of claim 11, wherein a waist diameter is configured to be sufficiently small to produce evanescent waves that couple to and from a device under test when the distance between the waist the device under test is sufficiently small.

13. The method of claim 12, wherein the legs extend in a direction out of a primary plane of the tapered polymer optical probe.

14. The method of claim 12, wherein the legs extend transversely outward in a primary plane of the tapered polymer optical probe forming a bulging bight shape with the waist.

15. The method of claim 12, wherein a cross-section of the waveguide is circular.

16. The method of claim 12, wherein a cross-section of the waveguide is oval.

17. The method of claim 12, wherein a cross-section of the waveguide is rectangular.

18. The method of claim 12, wherein a cross-section of the waveguide changes over its length.

19. The method of claim 12, wherein the substrate includes a fiber array.

20. The method of claim 12, wherein the substrate includes a multi-core fiber.

21. The method of claim 12, wherein the substrate includes a photonic integrated circuit.

22. The method of claim 9, wherein the waveguide has a leg diameter at proximal ends that tapers down to a waist diameter, the waist diameter being smaller than the leg diameter.
